(19) United States
(12) Patent Application Publication
(10) Pub. No.: US 2006/0047530 A1
(43) Pub. Date: Mar. 2, 2006

(54) Job placement system and method

(76) Inventors: Kim Hoi So, Houston, TX (US); Willy Ong, Houston, TX (US)

Correspondence Address: Browning Bushman P.C., Suite 1800, 5718 Westheimer, Houston, TX, 77057-5771, US

(21) Appl. No.: 10/930,940

(22) Filed: Aug. 31, 2004

(51) Int. Cl. G06Q 99/00

(52) U.S. Cl. 705/1

(57) ABSTRACT

In one preferred embodiment, job information and candidate information are compared to select a set of eligible candidates from a plurality of job candidates. A weight is assigned to each of a first plurality of parameters included with the job information. The candidate information is compared with the job information to identify for each eligible candidate a subset of the first plurality of parameters satisfied by each eligible candidate. The candidate information pertaining to the set of eligible candidates is communicated to the employer, and the job information is communicated to one or more of the eligible candidates. The eligible candidates are compared as a function of the weights assigned to the parameters within the candidates' respective subsets. One candidate is selected from the set of eligible candidates to fill the job opening. A placement fee is transferred from the employer to a placement agency, and at least a portion of the placement fee is transferred to the selected one candidate.

### FIELD OF THE INVENTION

The invention relates generally to a job placement system and method. More particularly, the invention relates to a novel system and method for matching and ranking candidates and for splitting fees.

### BACKGROUND

Traditionally, when a company wants to fill a newly created employment position, a Departmental Hiring Manager (DHM) will notify the Human Resources (HR) department. The DHM will pass along all the details and requirements of the position, and HR must then collect the information, transform it into a job description, and communicate the job description to any of a number of job placement resources. These resources commonly include:
1. Newspaper Advertisements. The job description must be distilled considerably, because newspapers commonly charge exorbitant rates on a per-word or per-column-inch basis. Much of the information regarding the position may be lost in translation to its short newspaper blurb, resulting in a high rate of superfluous inquiries from applicants not possessing the requisite skills.
2. Recruiting Agencies. HR or the DHM meet with a representative of the recruiting agency (“headhunter”) to discuss the details of the position. Time and money may be spent traveling to meet one another for this discussion, possibly over a meal charged to the company. The headhunter then accesses his or her own recruiting channels, including employment websites or the headhunter's own sites. The headhunter also contacts potential matches available within the headhunter's existing pool of applicants. A considerable amount of the headhunter's own time, money, and expertise is occupied during this placement process, and as a result, a hefty premium is commonly charged to the employer upon placement. For this reason, headhunter services are frequently out of reach of smaller or mid-sized companies and firms. Additionally, some companies and job candidates develop a distaste for and avoid headhunters, which may obfuscate communication of the details of the position
3. Job Placement Websites. Job placement websites are abundant. By and large these websites operate by posting job descriptions provided by employers and recruiting agencies, allowing applicants to access the job descriptions and make their interest in the position known, either directly or to a headhunter hired to fill the position. Hiring companies typically pay a hefty fee for placing an ad on one or more websites.
4. Unsolicited Inquiry. Applicants frustrated with or wishing to expand upon the conventional recruiting channels sometimes send unsolicited employment inquiries to potential employers. This is a percentage game, and applicants will frequently engage in mass-mailing of resumes to every company or firm for which the applicant might want to work. As a result, cover letters often go out that are inappropriately phrased to a particular company, evidencing the applicant probably mass-mailed his inquiry and has no specific knowledge of the employer. This is usually not well received, and the process is far from ideal.
5. Employee Referrals. Because of the inherent difficulties and expense of hiring through the channels described above, many positions are not advertised. Rather, someone in a company may already have in mind a number of potential applicants in the field who may satisfy the requirements of the position. For example, Company A might have dealings with and know people working for a competitor Company B, and A may contact and recruit an employee of B. In this scenario, the best person is not necessarily hired for the position; rather, the selection process is at least partially diminished for the sake of the “convenience” of selecting a candidate whom Company A already knows, bypassing consideration of a multitude of potentially more qualified applicants in the marketplace.

A primary problem with filling employment positions, therefore, lies in the inefficiencies currently inherent to communicating positions to the qualified applicant pool. Information is typically lost or degraded in its communication to a pool of applicants, in that the information is not accurately and completely communicated to all of the suitable applicants. Advertising and communicating the information is also costly.

FIG. 1 illustrates the inefficiency of conventional placement services with an example wherein three Hiring Companies (1-3) selectively access available recruiting channels, including newspapers, websites, recruiting firms, and direct employee referrals. A pool of applicants includes Qualified Applicants A-D. The Hiring Companies each determine which services they will use to communicate their respective positions. This process takes time, typically on the order of weeks or months. For example, HR for Hiring Company 1 (the employer) might contact and meet with a Placement Firm (the employer's headhunter) about the job opening. Next, the headhunter must process the information, along with many other positions he or she is handling. If a newspaper ad is also being placed, the employer must contact the newspaper, who in turn must create the ad, post the ad, etc., which may take another few weeks. Additional time and money resources are expended if any other recruiting channels are being used. It may then take time before job candidates become aware of the job opening. For example, an applicant may routinely check a website once every week or two, to allow time for new ads to be posted; or a headhunter might first contact the applicant having the highest earning potential (with the goal of maximizing his or her placement fee) before contacting other applicants; or a friend of one of the applicants might spot an ad in the newspaper and mail it to a Qualified Applicant friend at his/her convenience. The overall process is slow and inefficient.

FIG. 1 further illustrates the “data loss” resulting from inefficiencies in communicating available positions to the Qualified Applicants. The information is not effectively conveyed to all interested Qualified Applicants. Rather, Hiring Company 3 only utilizes newspaper and website resources. Simultaneously, Qualified Applicant D checks with placement firms, referrals from employees at companies he is aware of, and other avenues, but he fails to check websites or newspapers. The information from Hiring Company 3 therefore never reaches Qualified Applicant D, and a potential match unfortunately is never realized. In the meantime, the Qualified Applicants spend a great deal of time continuing to check all the available placement resources for another position, and the Hiring Companies continue to place ads which reach many people, but only a percentage of whom are qualified.

Some job placement resources use computers and the internet to facilitate the placement process, but they fail to fully take advantage of the automation that is achievable with these tools. The selection process is largely non-automated, and time consuming. For example, although an employer may have access to a large number of resumes, the employer must manually and inefficiently sort through those resumes to select candidates to interview. Furthermore, headhunters who use such online placement sites nevertheless typically use conventional, non-automated techniques to complete the placement: e.g. sifting through resumes, making many phone calls to company HR reps, etc. The power of computers and the internet is not fully captured.

Some internet-based placement resources partially automate the selection process by providing a minimal level of searchability. Resumes are uploaded into a computer system, and are typically searched by key words. This is not ideal, because every candidate structures his or her resume according to personal preferences, with no uniform standard of information organization. Larger companies, especially, use resume uploading and keyword searching that is notoriously inaccurate, often producing false matches. As an example, a company searching for a patent attorney might obtain a false match due to the phrase “patent leather shoes” located in the resume of a fashion designer. Too much time is required to further sift through the search results, and eligible candidates may be inadvertently overlooked.

Some internet-based placement resources incorporate the use of a fee-based structure as part of the placement process. U.S. Pat. App. 2003/182171, for example, describes how trade associations may earn fees by referring employers to a career site. Applicants submit their professional information in the form of anonymous “Talent Profiles,” which may be accessed by anonymous employers. Each time a complete talent profile is completed by talent and purchased by a referred employer, a referral fee is paid to the affiliate trade association by a career site operator. Alternatively, U.S. Pat. No. 6,681,223 describes how job web portal sites use their website as a source of revenue by charging a client company a registration fee and a finder fee for every successful employee hired. The job web-portal is simply contracted to do the search or the job web portal allows access in some limited way to the resumes from a company site.

Clearly, fee-based systems are attractive to participants receiving the fees as an incentive for their participation. Unfortunately, the known fee-based systems do not encourage active participation by all people participating in the hiring process, thus limiting the efficacy of paying fees to facilitate job placement.

### SUMMARY OF THE INVENTION

According to one preferred embodiment, a job placement method comprises entering job information candidate information into a database. The candidate information is compared with the job information to select a set of eligible candidates from the plurality of job candidates. The candidate information pertaining to the set of eligible candidates is communicated to the employer. The job information is communicated to one or more of the eligible candidates. One candidate is selected from the set of eligible candidates to fill the job opening. A placement fee is transferred from the employer to a placement agency. At least a portion of the placement fee is transferred to the selected one candidate. Another portion of the placement fee may be paid to an informant, wherein the informant provides at least a portion of the job information. The informant in some embodiments is an employee of the employer. A placement contract may be formed between the employer and the placement agency prior to selecting the set of eligible candidates

According to another aspect of a preferred embodiment, a weight may be assigned to each of a first plurality of parameters included with the job information, the first plurality of parameters including qualifications sought by the employer for the job opening. The candidate information may be compared with the job information to identify for each eligible candidate a subset of the first plurality of parameters satisfied by each eligible candidate. The eligible candidates may be compared as a function of the weights assigned to the parameters within the candidates' respective subsets. For each eligible candidate, a first sum may be computed equal to the sum of the weights assigned to the parameters within the respective subset, and a second sum may be computed equal to the sum of the weights assigned to the first plurality of parameters. A matching fraction may be computed for each eligible candidate equal to the first sum divided by the second sum. The eligible candidates may be compared according to their respective matching fractions, which may be expressed as percentages communicated to the employer.

A mandatory value may be assigned to each of a second plurality of parameters included with the job information. The second plurality of parameters may be compared with the candidate information, and job candidates who do not satisfy all of the second plurality of parameters may be excluded from the set of eligible candidates. Narrative information included with the candidate information may also be displayed to the employer, the narrative information further describing the qualifications of each eligible candidate.

### BRIEF DESCRIPTION OF THE DRAWINGS

FIG. 1 illustrates the inefficiency of prior art placement services.

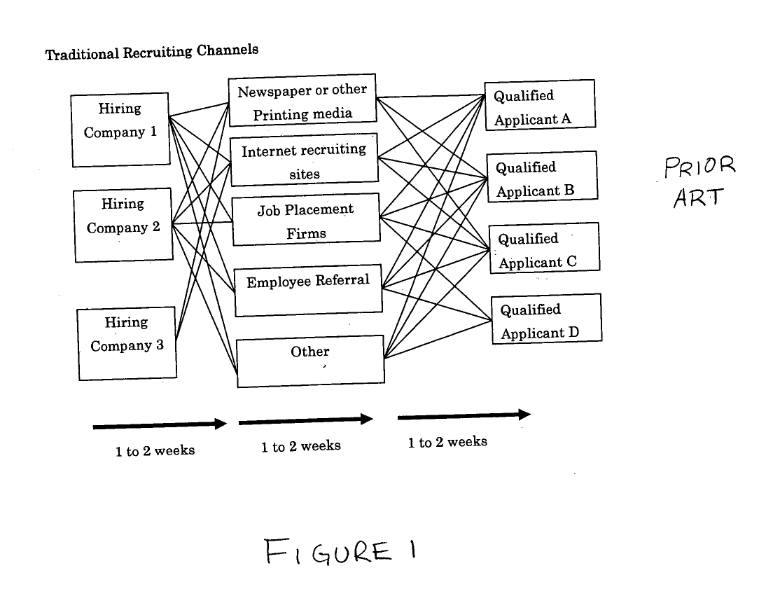

FIG. 2 is a flowchart presenting a general overview of a preferred embodiment of a job placement system and method (JPS).

FIG. 3 highlights the Applicant Dataflow Process.

FIG. 4 is an example of an online form for submitting an applicant's identification information.

FIG. 5 is an example of an online form for assenting to various user agreements.

FIG. 6 is a flowchart illustrating a process by which an applicant may interact with the JPS in the Qualifications and Job Profile Module.

FIG. 7 conceptually shows a form the applicant will use to enter candidate information within Qualification and Job Profile Module.

FIG. 8 shows an expanded portion of the FIG. 7 form.

FIG. 9 is a flowchart outlining an Applicant Information Verification Module.

FIG. 10 highlights an Informant Dataflow Process.

FIG. 11 is a flowchart describing some aspects of a preferred Job Requirements and Profile Module.

FIG. 12 conceptually shows a form the informant will use to enter candidate information within Job Requirements and Profile Module

FIG. 13 shows an expanded portion of the FIG. 12 form.

FIG. 14 is a flowchart illustrating a Job Availability Verification Module.

FIG. 15 is a conceptual example of how the results may be expressed on a computer as percentages in Hiring Firm Matching Result module.

FIG. 16 conceptually illustrates some aspects of an Interview Setup and Compensation Module.

FIG. 17 conceptually shows an example of a chart optionally provided by the JPS to help the employer track the placement process.

FIG. 18 conceptually shows an example of a chart optionally provided by the JPS to help a job candidate track the placement process.

FIG. 19 conceptually illustrates how a single JPS may be used to efficiently place all Qualified Applicants with Hiring Companies.

### DETAILED DESCRIPTION OF PREFERRED EMBODIMENTS

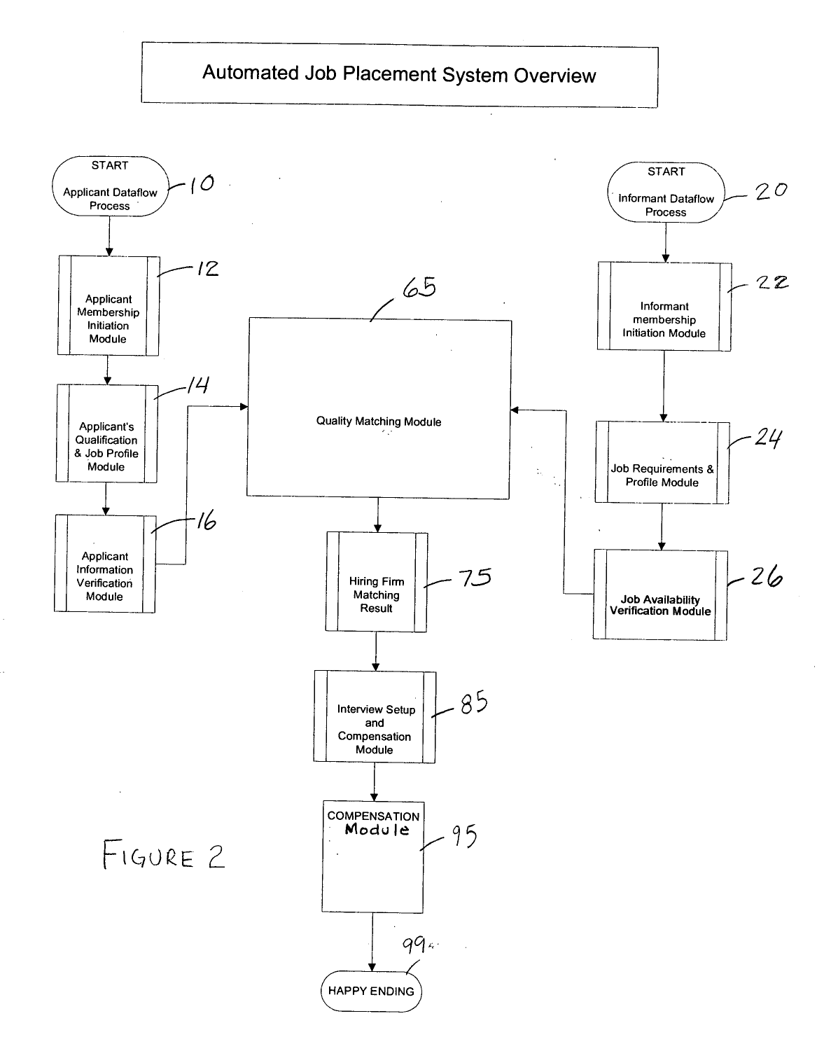

FIG. 2 is a flowchart presenting a general overview of a preferred embodiment of a job placement system and method (JPS). The flowchart includes an Applicant Dataflow Process 10 in which job candidates will interact with the JPS to provide candidate information, and an Informant Dataflow Process 20 in which informants will interact with the JPS to provide information about job openings. Job information and candidate information will be compared in Quality Matching Module 65 to evaluate the suitability of candidates for the job opening. Results from Module 65 will be displayed to an employer in Hiring Firm Matching Result Module 75. The employer may select candidates to interview in Interview Setup and Compensation Module 85. Finally, placement fees may be computed and paid to various participants in either or both of Module 85 and Compensation Module 95. This will preferably result in a “happy ending” 99.

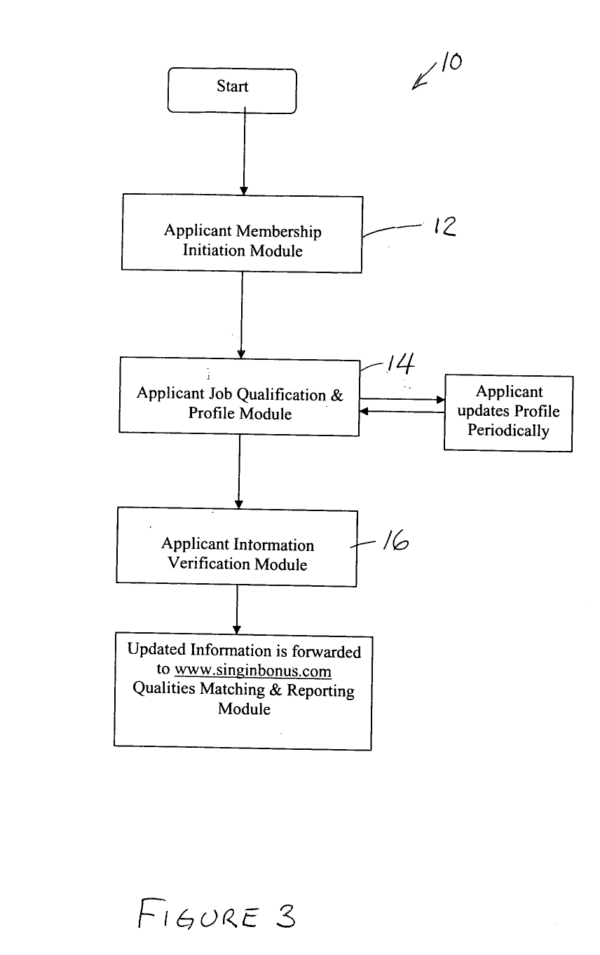

FIG. 3 highlights the Applicant Dataflow Process 10 by which job candidates (referred to interchangeably as “applicants”) will enter candidate information into an online database, which may be hosted on or managed by one or more central computers. In various embodiments, these computers may include computing devices such as a personal computer, computer, server, or even a PDA or cell phone. Candidate information includes any information about the applicant that an employer (referred to interchangeably as a “hiring company”) may want to know, such as personal identification, contact information, and job qualifications the applicant possesses. The applicant may first go through an Applicant Membership Initiation Module 12, which is preferably accessible online through a home PC. The applicant will create a unique login ID and password and enter his or her identification information.

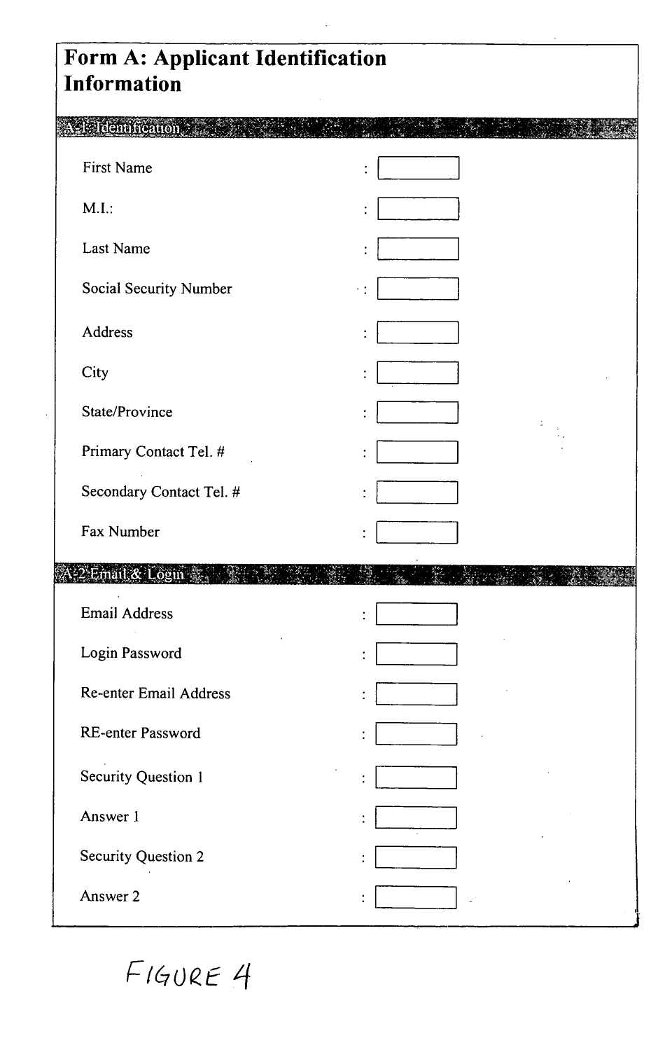

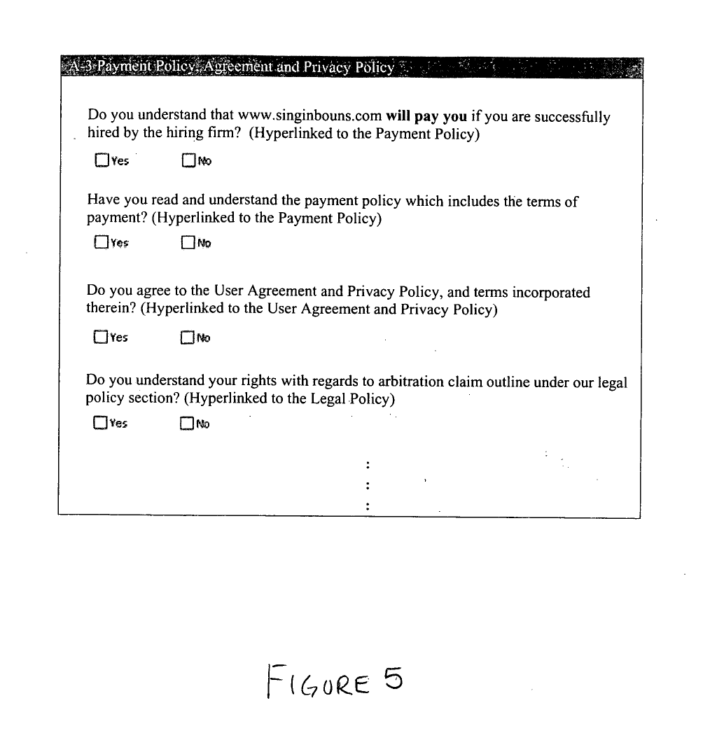

An example of an online form for submitting the applicant's identification information is shown in FIG. 4. In this Module 12, the applicant may also be required to read and assent to a payment agreement, user agreement, and/or privacy agreement. The applicant may subsequently update the database with his or her respective candidate information, as often as desired, for so long as the applicant is actively searching for jobs. An example of an online form for assenting to various user agreements is shown in FIG. 5. As indicated in FIG. 5, the JPS may be accessed through a website, such as may be hosted at www.signinbonus.com. The JPS and its respective website are preferably owned and operated by a third-party placement agency, but in some cases might alternatively be owned/operated by the same company providing the job opening(s).

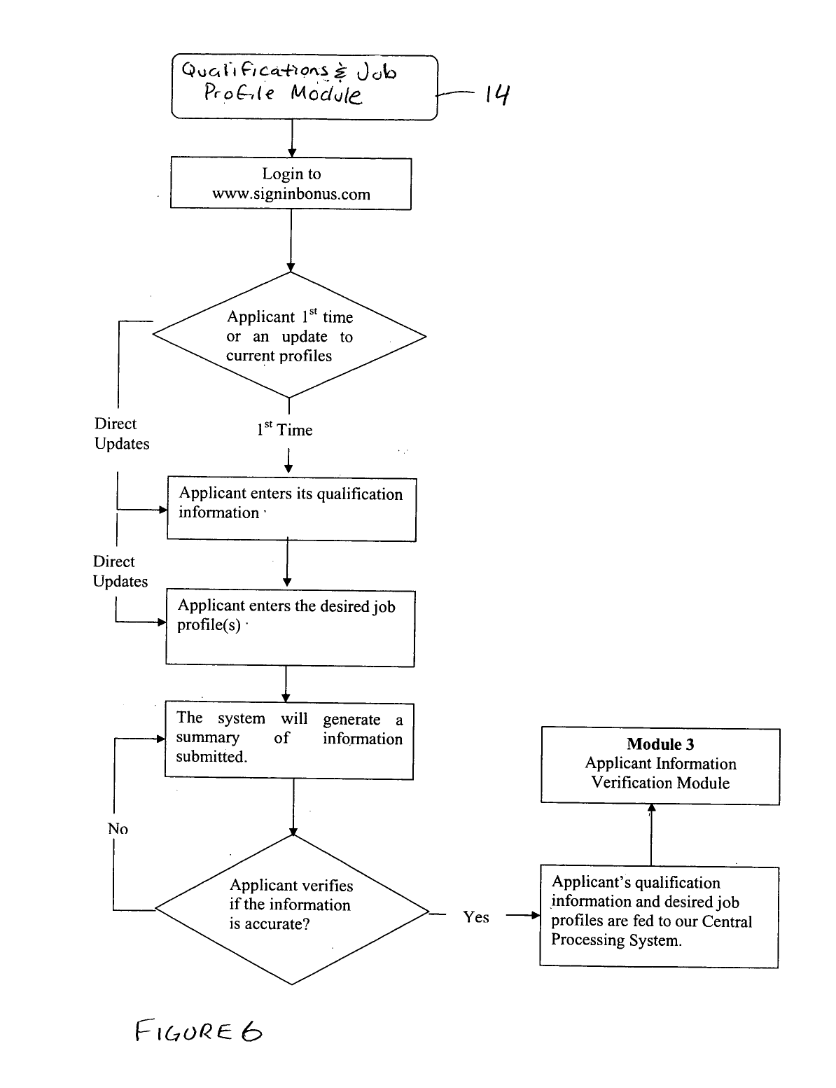

FIG. 6 is a flowchart illustrating a process by which an applicant may interact with the JPS in Qualification and Job Profile Module 14. In Module 14, the applicant will enter details regarding their qualifications and other data useful in evaluating the applicant for employment. This information includes “job profiles”, which refer to various job types the applicant may seek. For example, a person with an MBA degree may consider working as a financial advisor in a banking or investment environment, and may simultaneously be interested in alternatively working as a marketing strategist for a Fortune 100 company. Multiple job profiles allow the applicant to select, coordinate, and present those aspects of his or her candidate information that is best suited for each particular job type. This information will subsequently be fed to a Quality Matching Module, Module 65 (FIG. 2). The JPS may then evaluate each applicant's suitability for a particular position by assessing the relevancy of each applicant's candidate information with respect to the job information.

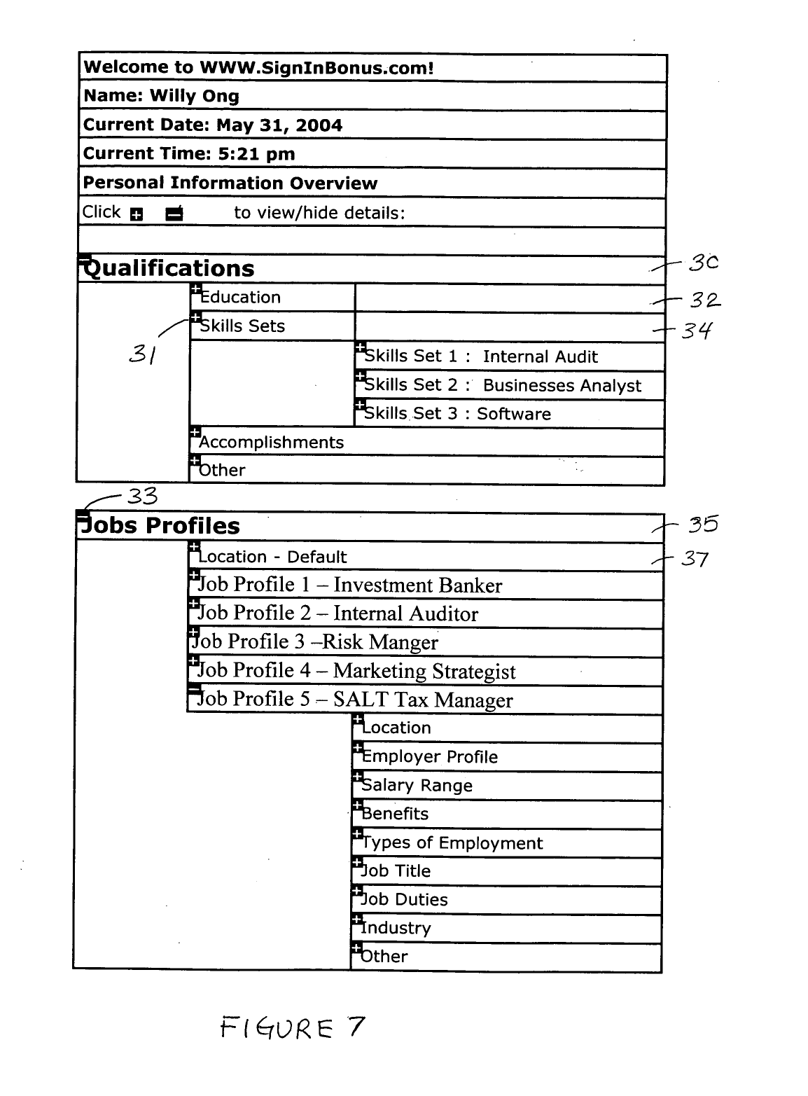

FIG. 7 conceptually shows a form the applicant will use to enter candidate information within Module 14. The form provides a number of categories of information, such as Qualifications category 30 and Jobs Profiles category 35. These categories branch into various subcategories, such as Education subcategory 32, Skills Sets category 34, and Location subcategory 37. The various categories can be alternatively opened or closed to show or hide subcategories and/or fields such as by “clicking” with a computer mouse on a “+” symbol 31 or a “−” symbol 33, respectively.

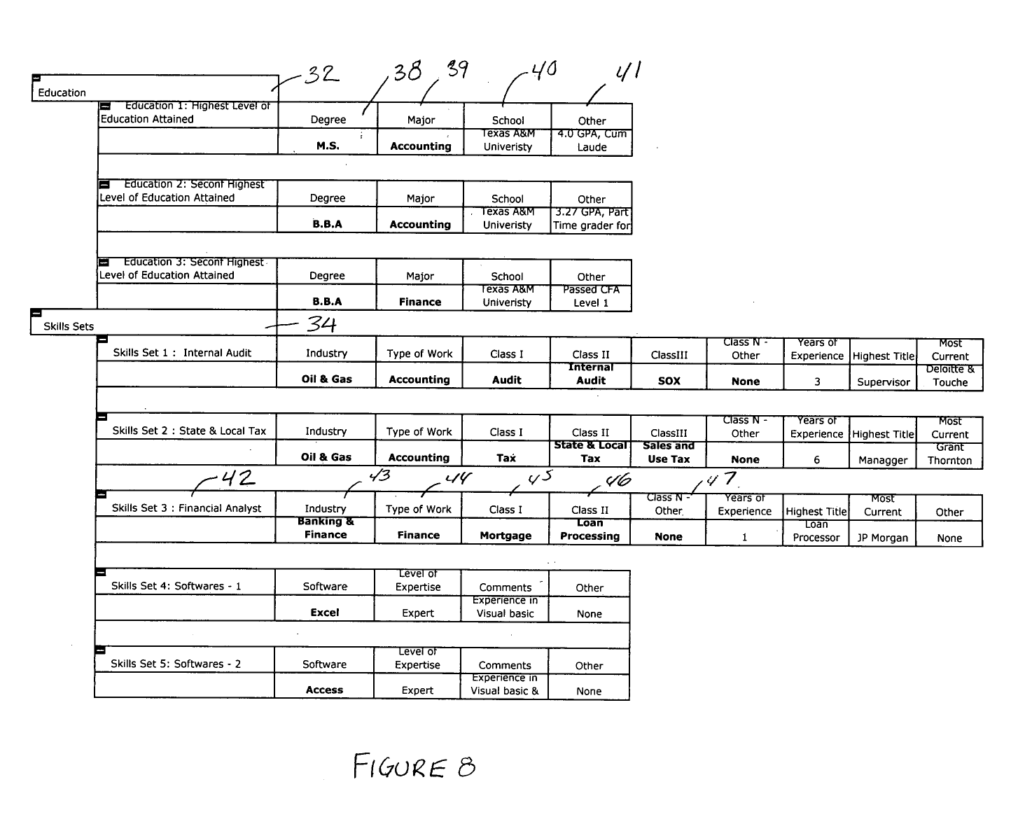

FIG. 8 shows an expanded portion of the FIG. 7 form, including Education category 32 and Skills Sets category 34, which, in this example, are both subcategories of Qualifications category 30. By expanding the various categories and subcategories a number of fields may be revealed, such as Degree field 38 Major field 39, School field 40, and Other field 41. At least some of the fields are preferably selected and organized such that information described in one field further modifies or refines that in an adjacent field. For example, under “Skills Set 3” category 42, a number of fields 43-47 are presented, wherein each field to the right is a “subfield” or modifier of the field to its left. To illustrate, within Industry field 43 the applicant has selected Banking and Finance; within Type of Work field 44 the applicant has selected Finance, which is the particular area of Banking and Finance in which the applicant worked; within Class I field 45 the applicant has chosen Mortgage, which is a particular type of Finance; under Class II field 46 the applicant has chosen Loan Processing, which is a particular area of specialty within Mortgage area; and so on. The categories, fields, and their particular organization within FIGS. 7 and 8 are purely for illustration, and are not intended to limit the JPS to any particular data fields or categories. Furthermore, the structure and format of FIGS. 7 and 8 is also conceptual. In preferred embodiments, the desired data entered into each field may be selected from a pull-down menu, but may alternatively be entered in other ways. Likewise, the method of opening and closing fields and subcategories is not limited to clicking on “plus and minus” symbols 31 and 33.

An important feature of the data entry as exemplified in FIGS. 7 and 8 is that the information may be structured into predesignated categories. The need for resumes is reduced or eliminated during the matching process in Quality Matching Module 65. Rather than by sorting through a plurality of applicant resumes, each having a different style and structure, the matching process allows applicants to be compared field-by-field, which lends itself to efficient and accurate computer automation. Resumes may still be used in the overall hiring process, however. For example, an applicant may use his or her resume as a reference when filling out the candidate information form(s), and an employer may still want to see resumes of candidates that have been selected for interviews.

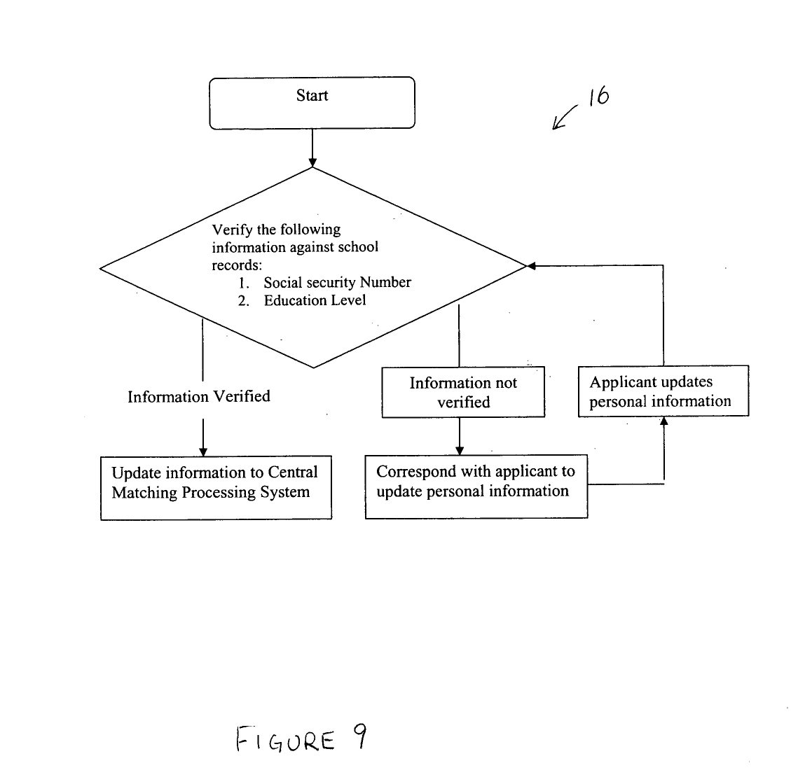

FIG. 9 is a flowchart outlining an Applicant Information Verification Module 16. The JPS may systematically verify personal information against public records. For example, the JPS may coordinate with online public data sources, governmental institutions such as licensing departments, schools, or other sources of public records and personal data. The Module 16 may eliminate, to a certain extent, some fraudulent or unscrupulous activities, such as identity theft or providing false candidate information, although it is not necessarily intended to provide a completely fraud-free environment.

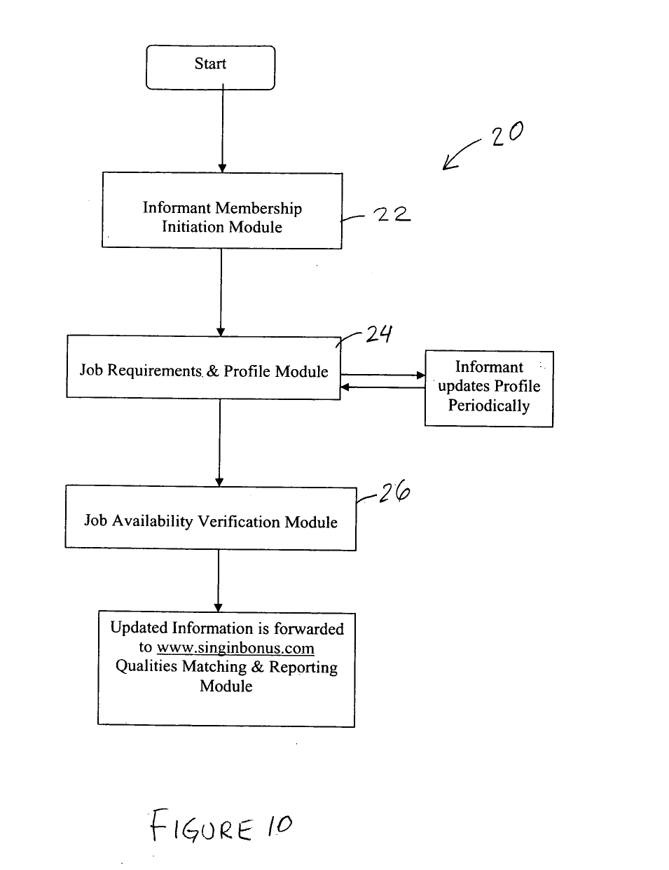

FIG. 10 highlights an Informant Dataflow Process 20 by which an informant may enter job information into the online database within the central computer. Job information generally pertains to a job opening provided by an employer, and typically includes qualifications the employer would like or require a job candidate to have. The informant can be anyone with credible information about the job opening. For example, the informant can be an existing employee of the employer. The informant will preferably enter the information in the manner outlined in FIG. 10. The informant will first go through an Informant Membership Initiation Module 22 to enter the informant's identification and login information. Forms for providing identification information and assenting to user agreements may be conceptually similar to those of FIGS. 4 and 5, although the informant's own information will instead be entered.

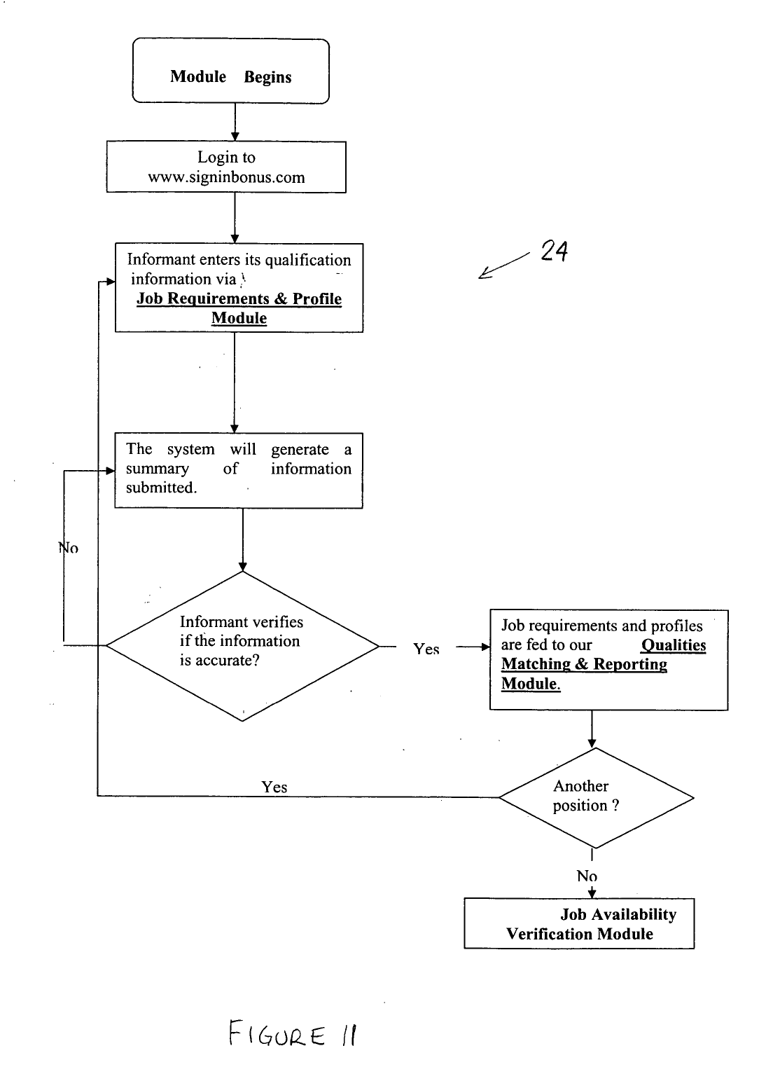

FIG. 11 is a flowchart describing some aspects of a preferred Job Requirements and Profile Module 24. The informant will enter the job requirements and other information for the position (“job opening”) about which he or she has knowledge. The informant may update job profiles periodically, such as to supply new or revised information about the position.

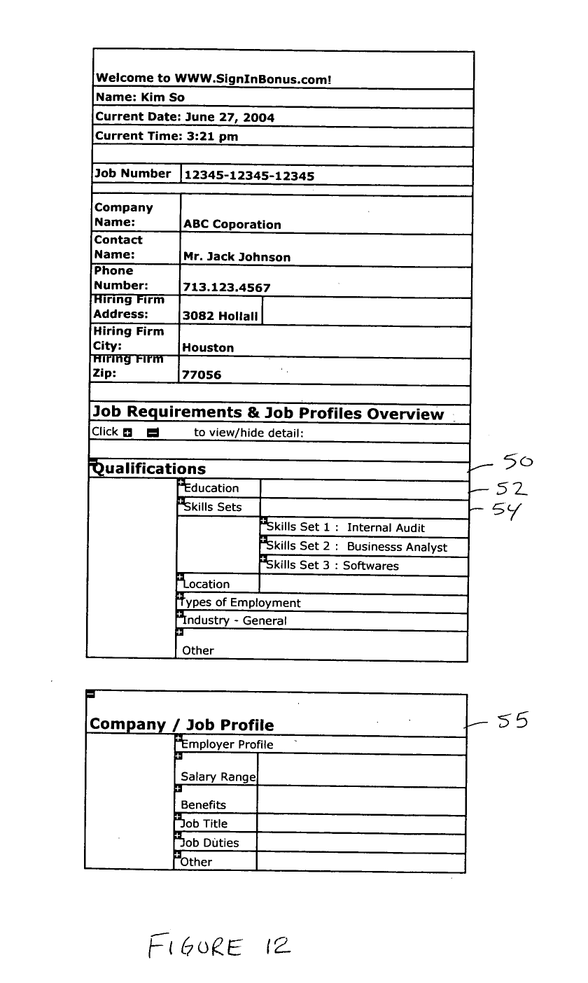

FIG. 12 conceptually shows a form the informant will use to enter candidate information within Module 24. The form may be compared conceptually with that of FIG. 7 used by applicants to enter candidate information, except that in the FIG. 12 form the informant will be entering job information. As with FIG. 7, a number of categories are included, such as main categories Qualifications 50 and Job Profile 55. Subcategories such as Education category 52 and Skills Sets category 54 are also included, except that these categories describe aspects of the job information, such as the educational background and skills sets desired in an applicant. The informant preferably enters all the information known to the informant, but upon formation of a placement agreement a representative of the employer, such as a hiring manager, will typically later revise, update, add, or at least verify information within the form.

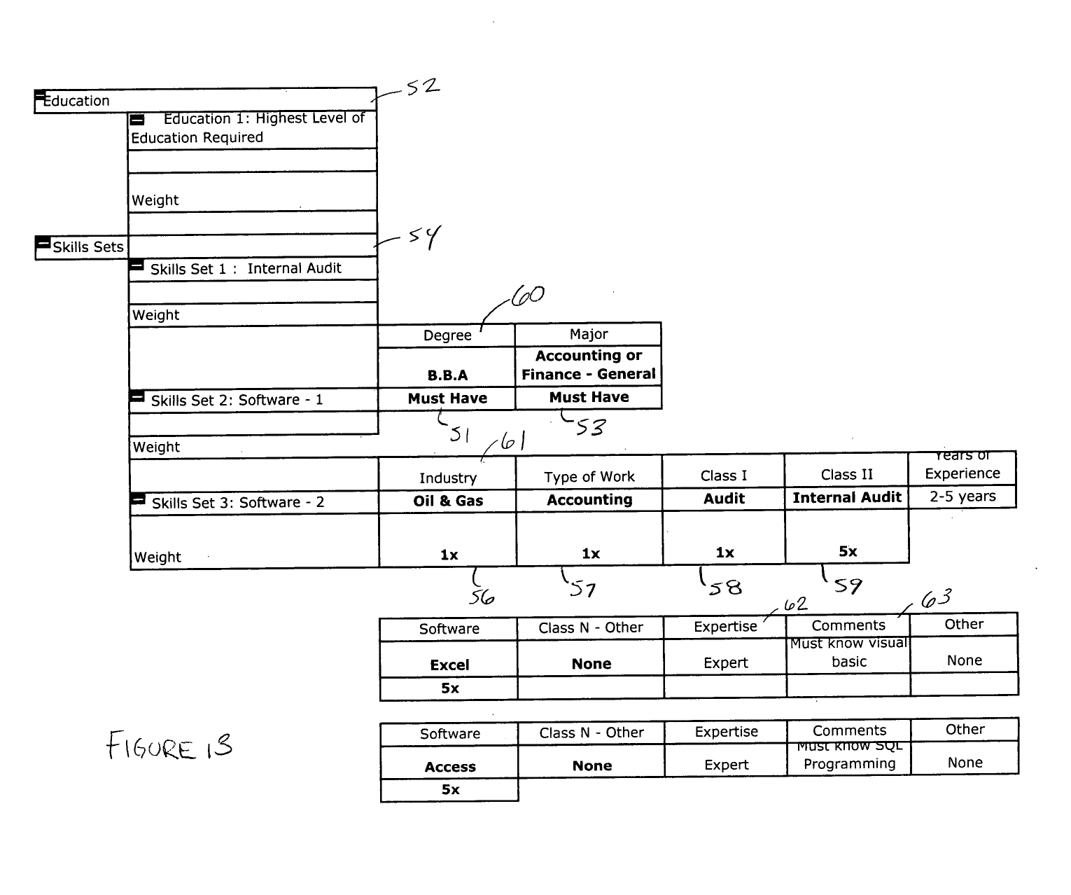

FIG. 13 shows an expanded portion of the FIG. 12 form. All or most of the fields, such as Degree field 60, Industry field 61, and Comments field 63, may be referred to as “parameters,” because their contents are selected by the informant and/or the employer to define the qualifications or other candidate traits sought by the employer. One parameter an employer may designate is a certain type of degree, and, for example, the contents of the Degree field 60 has been selected to be “B.B.A”. Another parameter is the industry in which a candidate acquired his or her software skills, and “Oil and Gas” has been selected for the parameter defined by field 61.

Some of the fields in FIG. 13, such as fields 51 and 53, have been filled in with the mandatory language “Must Have”, which is used to designate a parameter that an employer stipulates a candidate must satisfy to be considered “eligible” for the position. One way a computer may evaluate candidates with respect to this first type of field is to perform a Boolean comparison to return a true or false result, and excluding a candidate for whom the comparison returns at least one value of false. If the candidate fails to satisfy any of this first type field, i.e. if at least one of the Boolean values is false, then the candidate is preferably excluded from a set of eligible candidates. A second type of field has a corresponding weight that is typically assigned by the employer. The weights assigned to this second type of field or parameter are distinguishable from the value of the parameter. For example, the values of parameters defined by fields 56 to 59 are Oil & Gas, Accounting, Audit, and Internal Audit, respectively. The weights assigned to these parameters are 1x, 1x, 1x, and 5x, respectively. The weights are assigned to indicate the relative importance of each of the parameters. Together, these first two types of fields may be referred to for convenience as “Type A” parameters, the first type being referred to herein as Type A1 and the second type as Type A2. A third type of parameter, referred to as a “Type B” parameter, is a non-weighted parameter that simply includes narrative (i.e. explanatory) information within the field. Expertise field 62 and Comments field 63 are examples of Type B parameters. Type B parameters typically modify or clarify other fields and preferably modify/clarify Type A1 or A2 fields.

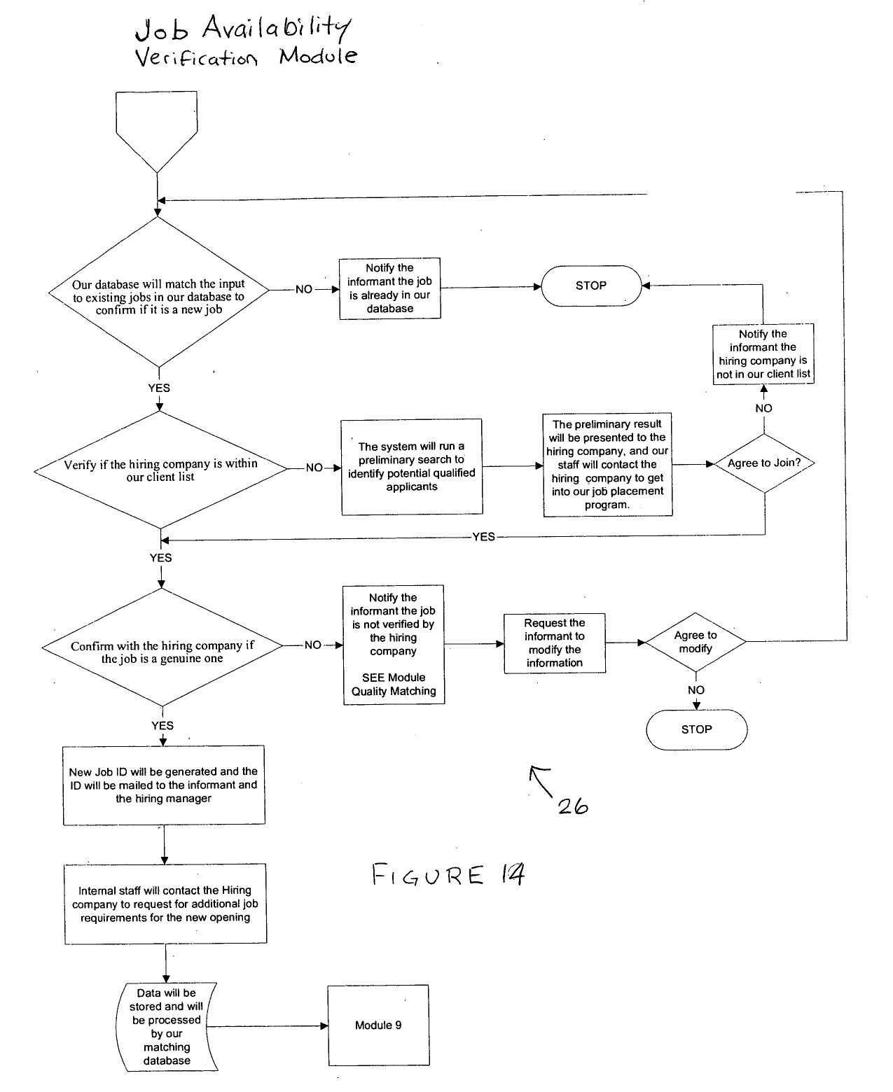

FIG. 14 is a flowchart illustrating a Job Availability Verification Module 26. Because the informant may conceptually be anyone, and in most cases will not be hiring personnel from the employer, it is a good idea to verify in advance that the informant has supplied correct and sufficient information about the position. The placement agency operating the JPS may first consult its database of employers to see if it has prior dealings with the particular employer offering the position. If the employer is not listed with the JPS, a representative should contact the company. The placement agency may explain the attributes and benefits of the JPS, including its low cost, its ability to generate a large pool of candidates, and its related ability to efficiently match the best possible candidate with the job opening. Some employers may occasionally consider information about the position to be confidential, or will otherwise elect not to participate in the JPS, instructing the JPS operator not to disclose the information to anyone. The JPS operator should respect that request. If the employer agrees to participate in the JPS, however, the placement agency may form a placement contract with the employer, setting forth the obligations of the employer and the placement agency with respect to selecting one of the candidates to fill the job opening.

After candidate information and job information has been input into the JPS, the Quality Matching Module 65 may be used to automatically and efficiently match job candidates with the job opening. The central computer may compare candidate information with the job information to select a set of eligible candidates from the plurality of job candidates. A preferred way to select the set of eligible candidates comprises the computer performing the Boolean comparison to eliminate those candidates not satisfying the Type A1 parameters (the “must have” job information fields). As a practical matter, this comparison may eliminate the vast majority of job candidates who are not well suited for the job opening. For example, if the JPS is matching candidates to an engineering position, the Boolean comparison may automatically eliminate those candidates not possessing an engineering degree. This desirably reduces the group of eligible candidates to a more manageable size.

The computer may then further evaluate the set of eligible candidates. In a preferred embodiment, the employer has already assigned weights to some of the parameters within the job information, such as weights 56 to 59 assigned to the Type A2 fields. The computer may compare the candidate information with the Type A2 job information to identify which of the Type A2 parameters each of the eligible candidates satisfies. Each candidate will thus satisfy a “subset” of the A2 parameters. This subset may include any number of A2 parameters, and may contain as few as zero or as many as all of the Type A2 parameters. The computer may then compare the eligible candidates as a function of the weights assigned to the parameters within the candidates' respective subsets. For example, a candidate satisfying all of the A2 parameters is likely to be compared favorably relative to another candidate satisfying few or none of the A2 parameters. A practical example of how candidates may be compared on the basis of these weights is to sum the weights for each candidate's subset of A2 factors. For example, a candidate may earn 8 “points” (1+1+1+5) by satisfying the A2 parameters with which the weights 56 to 59 are associated.

In a preferred embodiment, the eligible candidates may be compared on the basis of fractions and/or percentages computed as a function of the weights assigned to their subsets of A2 factors. For each eligible candidate, a first sum may be computed equal to the sum of the weights assigned to the parameters within the respective subset For instance, the numerator of a fraction for a candidate earning only the weights 56 to 59 in a particular category may be computed as 8 (the sum 1x+1x+1x+5x). A denominator may be computed as the sum of the weights assigned to all of the first plurality of parameters in the particular category. For instance, all of the A2 weights may add to 100. Thus, a candidate having 8/100 points in the particular category would have a “matching fraction” of 8/100, which may be conveniently expressed as a rating of 8%. Another candidate having 50 points within his or her subset would have a rating of 50%. These computations are preferably performed by the computer and subsequently displayed or otherwise communicated to the employer.

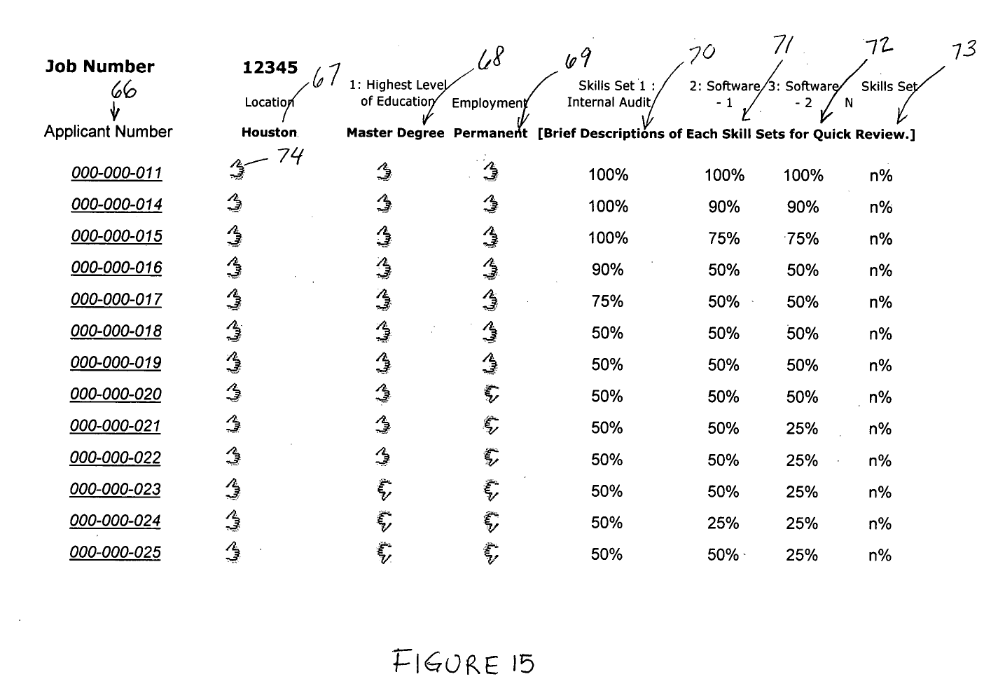

FIG. 15 is a conceptual example of how the results may be expressed on a computer as percentages in Hiring Firm Matching Result Module 75. Preferably, a group of higher-ranked applicants will be forwarded to the hiring manager by default. A number of applicants are identified by number in column 66. For purpose of illustration, not all applicants in this example are shown in the figure, but will preferably be displayed or optionally available for display to the employer. Type A1 factors (“must match”) are represented in columns 67 to 69. Type A2 (weighted) factors are shown in columns 70 to 73. The applicants are listed in decreasing order of relevancy in columns 70 to 73. For example, applicant −011 has a “thumbs-up” rating 74 for all of his categories of Type A1 factors, and 100% for all categories of Type A2 factors shown. Applicant −025 has only one thumbs-up symbol, indicating failure to satisfy all of the Type A1 criteria, and a score of 50% or less for each of the categories of Type A2 factors.

In a preferred embodiment, a default display would not include those candidates in FIG. 15 that do not satisfy all of the Type A1 parameters, because they have conceptually been eliminated from the set of eligible candidates in the Quality Matching Module 65. In some instances, however, it may be desirable for an employer to optionally display those candidates, such as if very few candidates or no candidates satisfied all the Type A1 parameters. In such cases, an employer may be willing to consider candidates previously eliminated from the set of eligible candidates. The JPS operator may elect to charge a fee to display additional candidates. Alternatively, the JPS operator may charge a fee for each candidate displayed. Thus, the employer could have the option to select the number of candidates and the extent of information to be displayed on the basis of the cost to display the various information.

Although not shown in FIG. 15, Type B (narrative/explanatory) information may also be displayed. In some embodiments, Type B info may be shown along with type A1 and A2 info. In other embodiments, such as to reduce screen clutter, the Type B candidate info may not be displayed until an employer clicks on a particular candidate number. Such an action may display to the user further details about a particular candidate, such as Type B information, contact information, and so forth. The placement agency operating the JPS may charge an additional fee to click on each candidate to access further information. Certain information, such as candidate identification, may be withheld from the employer until the employer accesses a particular candidate's profile, which the employer may need to do in order to establish an interview.

The novel display of FIG. 15 may alternatively be referred to as an embodiment of an “employment matching report.” The report includes a display of a candidate identifier for each of a plurality of job candidates. In FIG. 15, the candidate identifiers are the Applicant Numbers in Column 66. A numerical display is also included in Columns 71-73 for each of the plurality of job candidates. As discussed previously, the numerical values may be matching fractions, which may be expressed as percentages. The numerical display is the value of a function of the plurality of weights assigned to the first plurality of parameters satisfied by the respective job candidate (i.e. the candidate's respective subset of the first plurality of parameters). A display of one or more Boolean values is also included indicating whether the job candidate has satisfied one or more of a second plurality of parameters contained within the job information. In the FIG. 15 embodiment, the Boolean values are the “thumbs-up” and “thumbs-down” symbols in Columns 67-69. These symbols represent Boolean values because they are limited to only two choices. A display of the narrative information (not shown) regarding the qualifications of one or more of the job candidates may also be included.

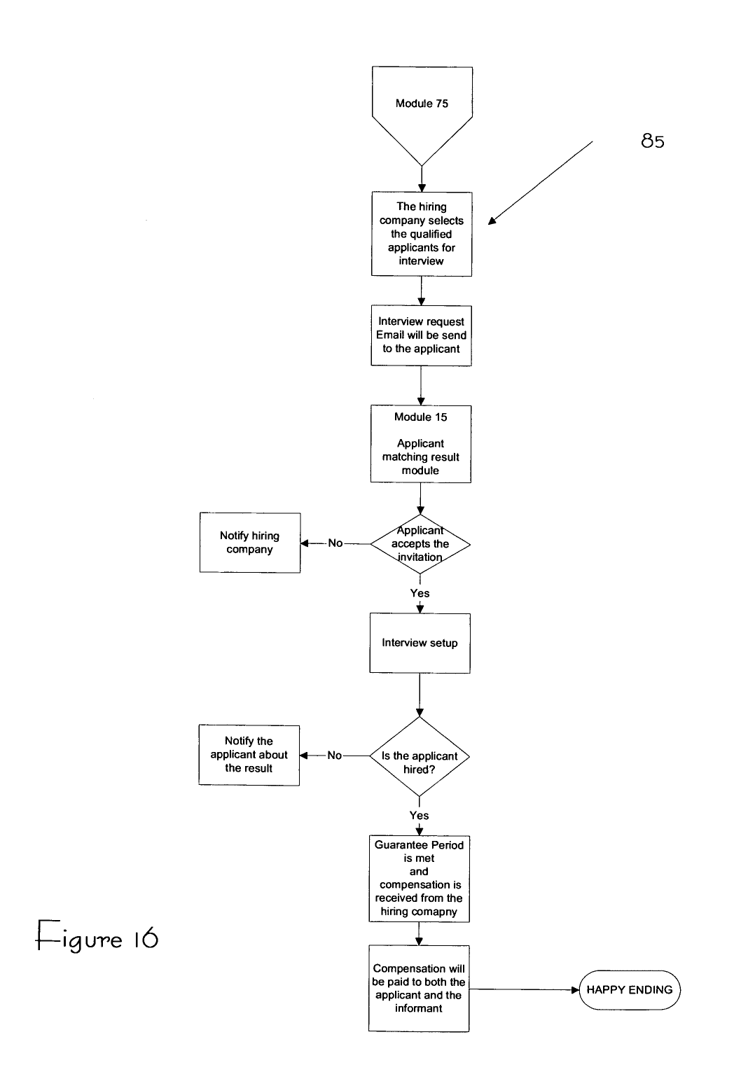

Although the JPS helps match candidates by eliminating some candidates and ranking other candidates based on relevance, it does not make the decision who to hire. Ultimately, it is up the employer to decide who to interview, and the employer and one of the candidates will ultimately be responsible for establishing an employment agreement. Once an employer has reviewed the matching results in Module 75, the employer will typically want to conduct a formal interview of candidates in order to make a final selection of one job candidate to fill the job opening. FIG. 16 conceptually illustrates some aspects of an Interview Setup and Compensation Module 85. Various features may be included within Module 85 for facilitating the interview and placement process. Upon matching a job candidate with an employer, for example, a calendar may be displayed on a computer screen accessible to the employer and candidate. The calendar may show available interview time slots, allowing the candidate to select the preferred time slot. Upon mutual agreement to release one another's identity, the JPS may allow further access to detailed information in the employer and candidate's profiles. The JPS may provide a messaging service to keep the employer and candidates apprised of upcoming deadlines, including interview times, as well as any emergency rescheduling. The computer may also show the status of the placement process during the various stages, such as after an agreement to interview but before the interview has occurred; after an interview pending a decision whether to make an offer to the candidate; and after an offer has been made pending acceptance of the offer by the candidate.

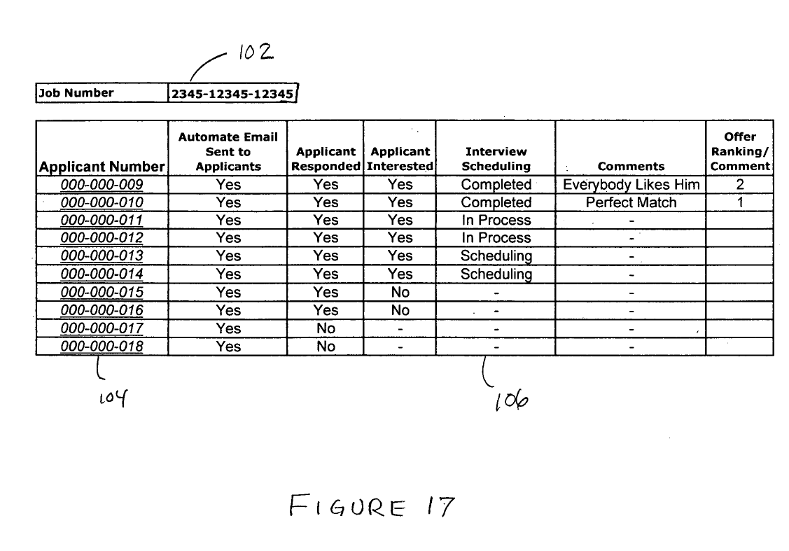

FIG. 17 conceptually shows an example of a chart optionally provided by the JPS to help the employer track the placement process. Field 102 lists the job number. Column 104 lists by number the applicants that the employer is considering. Column 106 provides an interview status for each applicant. Other informational columns and fields are shown, and still others may be included, to facilitate the placement process.

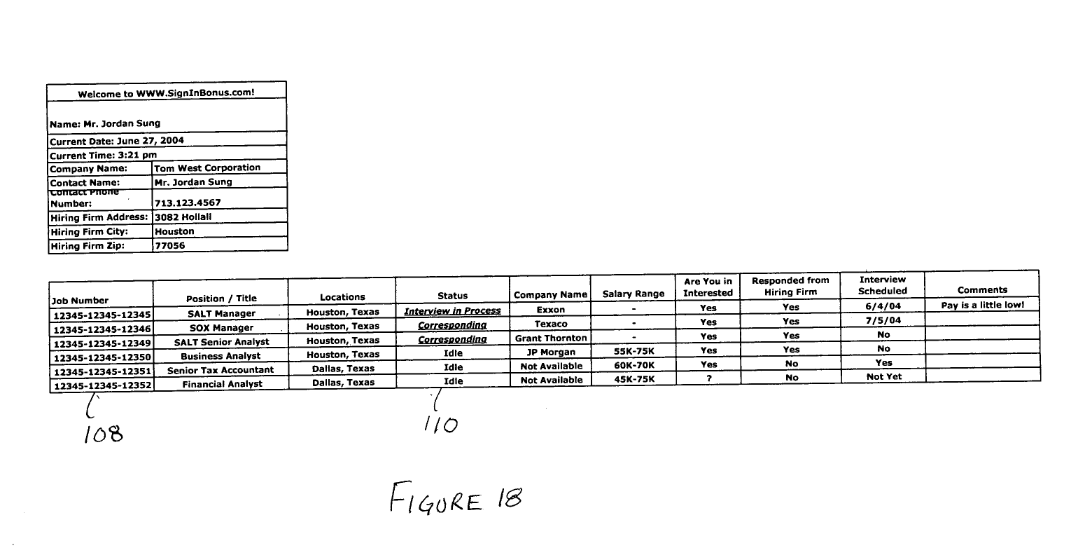

FIG. 18 conceptually shows an example of a chart optionally provided by the JPS to help a job candidate track the placement process. Column 108 lists by number various job openings the candidate is considering. Column 110 indicates the status of the possible placement, such as “interview in process” if an interview has already been agreed to, “corresponding” if the employer and candidate are in preliminary negotiations, and “idle” if nothing has transpired yet between the candidate and the employer. Other informational columns and fields are shown, and still others may be included, to facilitate the placement process.

Another feature of the JPS is a self-updating feature. The fields included for defining various parameters of candidate information and job information preferably have preset choices, such as by using pull-down computer menus. Ideally, all possible choices would be included for each field. As a practical matter, the best choice for a particular field may not be included in the available choices. If “other” information is frequently entered into the system, the computer may track that “other” choice, and eventually add it to the menu of choices. The choice of “other” is preferably included with most or all of Type A information, and particularly Type A2 (weighted) information.

Another “updating” feature is that as employers and informants acquire new, improved, or revised job information, they may log in to the system and update it. Likewise, candidates may log in to the system to supply new, improved, or revised candidate information.

The invention further provides a novel fee-splitting arrangement. Upon selecting one candidate from the set of eligible candidates to fill the job opening a placement fee is transferred from the employer to the placement agency operating the JPS. One novel aspect of the fee-splitting arrangement is that at least a portion of the placement fee is transferred to the selected one candidate. Another portion of the placement fee may be transferred to an informant who provided at least a portion of the job information. In some instances, the informant may be an employee of the employer. Employees will often know about unpublished positions within their company or firm, even when they lack official hiring capacity. This fee splitting arrangement can provide incentives to the job candidates to use the JPS, and provide incentives to employee or other informants to disclose job openings.

The pool of applicants is helped out by the publication of more jobs. With conventional placement systems and methods, many job openings might not be publicized, such as if hiring personnel lack the funding, motivation, knowledge, or understanding of various placement services. For example, older hiring personnel might not be up to date on modern internet-based placement, or companies on a budget might be intimidated by the high prices of such services. The invention will ultimately introduce to such companies the benefits of modern placement technology. After being informed by the company employee about a job opening, the JPS operator may contact the hiring company to make it aware of its valuable job placement service. The JPS operator can explain the fee-based system, which may be significantly less expensive than other placement services.

Another advantage is that the JPS may allow the job seeker who signs in and participates in the JPS to share the referral fees in the form of a “sign in bonus”. Previous job placement services have either charged fees to job seekers or merely provided free access to the job seeker. Never has the job seeker been paid a fee directly by the placement service.

The JPS may provide further monetary rewards to the job applicant by reducing placement costs. According to previous job placement systems and methods in which headhunters participate, the job applicant effectively lost money because the hiring companies have had to budget for both the compensation to the employee and a hefty fee to the headhunter of as much as a third of the negotiated salary. This will further encourage the applicant to register with the JPS, affording a significant commercial advantage to the JPS.

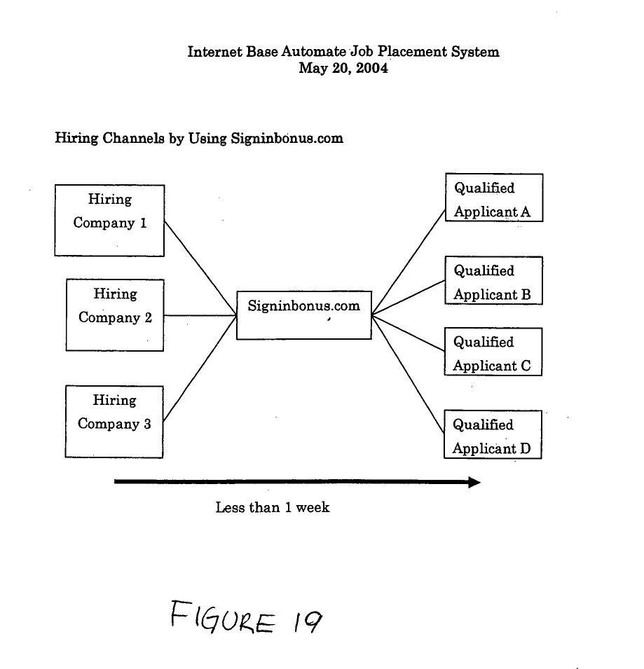

The net result of the JPS is a streamlining of the placement process. FIG. 19 illustrates how a single JPS operated at “Signinbonus.com” may be used to place all Qualified Applicants with Hiring Companies. By going directly through the JPS, the employer/employee community may more efficiently perform its job placement function. As more people become aware of the JPS, the community may increasingly rely upon and use the JPS, rendering other placement services obsolete. Because prior systems did not pay job seekers to advertise their talents, the JPS according to the invention has a competitive advantage in obtaining job placement information in a manner that is uniform, structured, easily matched, and continuously updated. This will generate a very large database of useful and up-to-date information about jobs and qualified applicants in a very short period of time. Upon creating a very large pool of jobs and job applicants, the hiring company has the incentive to use the JPS because it streamlines the placement process into one recruiting channel instead of a disjointed collection of existing methods.

Although specific embodiments of the invention have been described herein in some detail, this has been done solely for the purposes of explaining the various aspects of the invention, and is not intended to limit the scope of the invention as defined in the claims which follow. Those skilled in the art will understand that the embodiment shown and described is exemplary, and various other substitutions, alterations, and modifications, including but not limited to those design alternatives specifically discussed herein, may be made in the practice of the invention without departing from its scope.

1. A job placement method, comprising:
entering job information into a database, the job information pertaining to a job opening provided by an employer;
entering candidate information pertaining to each of a plurality of job candidates into the database;
communicating the candidate information pertaining to a set of eligible candidates from the plurality of job candidates to the employer;
communicating the job information to one or more of the eligible candidates;
selecting one candidate from the set of eligible candidates to fill the job opening;
transferring a placement fee from the employer to a placement agency; and
transferring at least a portion of the placement fee to the selected one candidate.

2. A job placement method as defined in claim 1, further comprising:
paying another portion of the placement fee to an informant, wherein the informant provides at least a portion of the job information.

3. A job placement method as defined in claim 1, wherein the job candidates enter the candidate information.

4. A job placement method as defined in claim 1, further comprising:
forming a placement contract between the employer and the placement agency prior to selecting the set of eligible candidates, the placement contract setting forth the obligations of the employer and the placement agency with respect to selecting one of the eligible candidates for the job opening.

5. A job placement method as defined in claim 1, further comprising:
assigning a weight to each of a first plurality of parameters included with the job information, the first plurality of parameters including qualifications sought by the employer for the job opening;
comparing the candidate information with the job information to identify for each eligible candidate a subset of the first plurality of parameters satisfied by each eligible candidate; and
comparing the eligible candidates as a function of the weights assigned to the parameters within the candidates' respective subsets.

6. A job placement method as defined in claim 5, further comprising:
for each eligible candidate, computing a first sum equal to the sum of the weights assigned to the parameters within the respective subset;
computing a second sum equal to the sum of the weights assigned to the first plurality of parameters;
computing a matching fraction for each eligible candidate equal to the first sum divided by the second sum; and
comparing the eligible candidates according to their respective matching fractions.

7. A job placement method as defined in claim 6, further comprising:
expressing the matching fractions as percentages and communicating the percentages to the employer.

8. A job placement method as defined in claim 1, further comprising:
assigning a mandatory value to each of a second plurality of parameters included with the job information, the second plurality of parameters including qualifications for the job opening;
comparing each of the second plurality of parameters with the candidate information; and
excluding from the set of eligible candidates each job candidate who does not satisfy all of the second plurality of parameters.

9. A job placement method as defined in claim 1, further comprising:
displaying narrative information included with the candidate information, the narrative information further describing the qualifications of each eligible candidate.

10. A job placement method, comprising:
entering job information into a database, the job information pertaining to a job opening provided by an employer, the job information being supplied and entered by one or both of the employer and an informant;
entering candidate information pertaining to each of a plurality of job candidates into the database, the candidate information supplied by the job candidates;
comparing the candidate information with the job information to select a set of eligible candidates from the plurality of job candidates;
assigning a weight to each of a first plurality of parameters included with the job information, the first plurality of parameters including qualifications sought by the employer for the job opening;
comparing the candidate information with the job information to identify for each eligible candidate a subset of the first plurality of parameters satisfied by each eligible candidate;
defining for each eligible candidate a function of the weights assigned to the parameters within the respective subset of the first plurality of parameters;
communicating the candidate information pertaining to the set of eligible candidates to the employer;
communicating the job information to one or more of the eligible candidates; and
selecting one candidate from the set of eligible candidates to fill the job opening.

11. A job placement method as defined in claim 10, further comprising:
for each eligible candidate, computing a first sum equal to the sum of the weights assigned to the parameters within the respective subset;
computing a second sum equal to the sum of the weights assigned to the first plurality of parameters;
computing a matching fraction for each eligible candidate equal to the first sum divided by the second sum; and
comparing the eligible candidates according to their respective matching fractions.

12. A job placement method as defined in claim 11, further comprising:
expressing the matching fractions as percentages and communicating the percentages to the employer.

13. A job placement method as defined in claim 10, further comprising:
assigning a mandatory value to each of a second plurality of parameters included with the job information, the second plurality of parameters including qualifications for the job opening;
comparing each of the second plurality of parameters with the candidate information; and
excluding from the set of eligible candidates each job candidate who does not satisfy all of the second plurality of parameters.

14. A job placement method as defined in claim 10, further comprising:
displaying narrative information included with the candidate information, the narrative information further describing the qualifications of each eligible candidate.

15. A job placement method, comprising:
entering job information into a database, the job information pertaining to a job opening provided by an employer, the job information being supplied and entered by one or both of the employer and an informant;
entering candidate information pertaining to each of a plurality of job candidates into the database;
comparing the candidate information with the job information to select a set of eligible candidates from the plurality of job candidates;
assigning a weight to each of a first plurality of parameters included with the job information, the first plurality of parameters including qualifications sought by the employer for the job opening, and comparing the candidate information with the job information to identify for each eligible candidate a subset of the first plurality of parameters satisfied by each eligible candidate;
defining for each eligible candidate a function of the weights assigned to the parameters within the respective subset of the first plurality of parameters;
communicating the candidate information pertaining to the set of eligible candidates to the employer, and communicating the job information to one or more of the eligible candidates;
selecting one candidate from the set of eligible candidates to fill the job opening; and
transferring a placement fee from the employer to a placement agency, and transferring at least a portion of the placement fee to the selected one candidate.

16. A method as defined in claim 15, wherein selecting the set of eligible candidates comprises:
assigning a mandatory value to each of a second plurality of parameters included with the job information, the second plurality of parameters including qualifications for the job opening;
comparing each of the second plurality of parameters with the candidate information; and
excluding from the set of eligible candidates each job candidate failing to satisfy all of the second plurality of parameters.

17. A job placement method as defined in claim 15, further comprising:
for each eligible candidate, computing a first sum equal to the sum of the weights assigned to the parameters within the respective subset;
computing a second sum equal to the sum of the weights assigned to the first plurality of parameters;
computing a matching fraction for each eligible candidate equal to the first sum divided by the second sum; and
comparing the eligible candidates according to their respective matching fractions; and
expressing the matching fractions as percentages and communicating the percentages to the employer.

18. A job placement method as defined in claim 17, further comprising:
displaying narrative information included with the candidate information, the narrative information describing qualifications of each eligible candidate pertaining to the subset of the first plurality of parameters satisfied by each eligible candidate.

19. A job placement method as defined in claim 15, further comprising:
paying another portion of the placement fee to the informant.

20. A job placement method as defined in claim 19, wherein the job candidates enter the candidate information.

21. An employment matching report, comprising:
a display of a candidate identifier for each of a plurality of job candidates;
a numerical display for each of the plurality of job candidates of a function of a plurality of weights assigned to a first plurality of parameters satisfied by the respective job candidate, the first plurality of parameters contained within job information pertaining to a job opening provided by an employer;
a display of one or more Boolean values indicating whether the job candidate has satisfied one or more of a second plurality of parameters contained within the job information; and
a display of narrative information regarding the qualifications of one or more of the job candidates.

22. An employment matching report as defined in claim 21, wherein the numerical display of the function for each job candidate further comprises:
a matching fraction, wherein the numerator is equal to the sum of the weights assigned to the first plurality of parameters satisfied by the respective job candidate, and the denominator is equal to the sum of the weights assigned to the first plurality of parameters.

23. An employment matching report as defined in claim 21, wherein the matching fractions are expressed as percentages.
